(19) United States
(12) Patent Application Publication
(10) Pub. No.: US 2020/0130454 A1
(43) Pub. Date: Apr. 30, 2020

(54) METHOD OF OPERATING VEHICLE CONTROL SYSTEM

(71) Applicant: Air Lift Company, Lansing, MI (US)

(72) Inventors: Aaron V. Lundy, DeWitt, MI (US); Julian M. Quick, Lansing, MI (US); Lucas J. Schaar, Lansing, MI (US); Tom Zagotta, Brighton, MI (US)

(21) Appl. No.: 16/174,466

(22) Filed: Oct. 30, 2018

(51) Int. Cl. B60G 17/052; B60G 17/015

(52) U.S. Cl. CPC B60G 17/052; B60G 17/0155; B60G 2202/152; B60G 2800/162; B60G 2600/182; B60G 2500/30; B60G 2500/201

(57) ABSTRACT

A vehicle control system, such as for an air suspension system of a vehicle, includes a control module having a sleep state and an awake state. Methods for operating the control system use a wake trigger to switch the control module, which is electrically coupled with a vehicle battery, from the sleep state to the awake state.

### BACKGROUND

The present invention relates to vehicle control systems having control modules, including vehicle control systems for an air suspension system.

Air suspension systems are known for providing a softer, more comfortable ride for a vehicle. Other common applications for air suspension systems include: raising or lowering a vehicle; leveling a vehicle that is under a load; leveling recreational vehicles parked on inclined surfaces; and altering the performance characteristics of a vehicle. Conventional air suspension systems include one or more pneumatic devices, such as air springs, connected between the vehicle axles and the vehicle chassis. Pressurized air from an air compressor can be forced into or exhausted from one or more of the air springs to provide the vehicle with desired suspension characteristics. An electronic power control module is provided for controlling the inflation and deflation of the air springs. Such a system may be installed on a vehicle by the original equipment manufacturer, or they may be purchased as aftermarket products that are substitutes or supplements for conventional steel spring suspensions.

For many years, control modules have been coupled with the ignition source of the vehicle, and have used a mechanical ignition switch providing a 12V ignition signal to enable the control module. The ignition signal has been used as either a trigger to wake-up the control module or has been used to directly power the control module. In both scenarios, while the ignition switch is off, the control module draws very little electrical current, which preserves the vehicle battery life. Control modules that do not have a low-current sleep state will put a constant drain on the battery, until the vehicle can no longer be started. For original equipment manufacturers, a low-current sleep state is required and in aftermarket products, a low-current sleep state is highly desirable.

In recent years, many vehicles have eliminated the reliance on the 12V switched ignition signal, and instead use a wired communication bus, such as controller area network (CAN) bus, to wake-up the control module from the low-current sleep state. However, by relying on a wired communication bus wake-up message, it is difficult for aftermarket products to be integrated into the vehicle and still maintain a low-current sleep state when the vehicle is off since the messages are often confidential and can sometimes stays active well after the vehicle is turned off.

In either case, it can be very difficult to find an ignition or CAN source since wiring diagrams are not made available to the general public and the circuit complexity of vehicle harnesses has grown exponentially. Diagrams typically have to be purchased or are only released to authorized dealers. This makes it nearly impossible for the typical end customer to find the proper source for connection of an aftermarket control module.

### BRIEF SUMMARY

The present invention provides a vehicle control system having a control module with sleep and awake states, and methods for operating the same. In some aspects, a method is provided for operating a control system for an air suspension system of a vehicle having a battery and an air spring adapted to inflate and deflate in order to raise and lower the height of the vehicle.

In one embodiment, the method includes providing a control module, electrically coupled with the battery, with a default sleep state comprising a low power mode, generating a wake trigger to switch the control module from the sleep state to an awake state, wherein the wake trigger is at least one of a periodic wake trigger automatically generated after the elapse of a predefined time interval or an aperiodic wake trigger generated after the detection of movement of the vehicle, and switching the control module from the awake state to back to the sleep state after a predefined wake period.

In another embodiment, the method includes providing a control module with a default sleep state comprising a low power mode, generating a wake trigger to switch the control module from the sleep state to an awake state, determining if the vehicle is moving or not moving, and switching the control module from the awake state to back to the sleep state if the vehicle is determined to be not moving.

In yet another embodiment, the method includes providing a control module with a default sleep state comprising a low power mode, determining if the vehicle is moving or not moving, and generating a wake trigger to switch the control module from the sleep state to an awake state if the vehicle is determined to be moving.

The present invention provides an effective control system with a low current draw, offers a flexible remote operation, and/or can reduce install time. These and other objects, advantages, and features of the invention will be more fully understood and appreciated by reference to the description of the current embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a representative view of a vehicle having an air suspension control system according to one embodiment of the invention;

FIG. 2 is a representative view of the control system of FIG. 1;

FIG. 3 is a schematic view of a control module of the control system of FIG. 1;

FIG. 4 is a perspective view of one embodiment of a remote control device of the control system of FIG. 1;

FIG. 5 is a perspective view of another embodiment of a remote control device of the control system of FIG. 1;

FIG. 6 is a process flow chart showing a method of operating an air suspension control system according to one embodiment of the invention;

FIG. 7 is a process flow chart showing a method of operating an air suspension control system according to another embodiment of the invention;

FIG. 8 is a process flow chart showing a method of operating an air suspension control system according to another embodiment of the invention;

FIG. 9 is a process flow chart showing a method of operating an air suspension control system according to another embodiment of the invention; and

FIG. 10 is a process flow chart showing a method of operating an air suspension control system according to another embodiment of the invention.

### DESCRIPTION OF THE CURRENT EMBODIMENT(S)

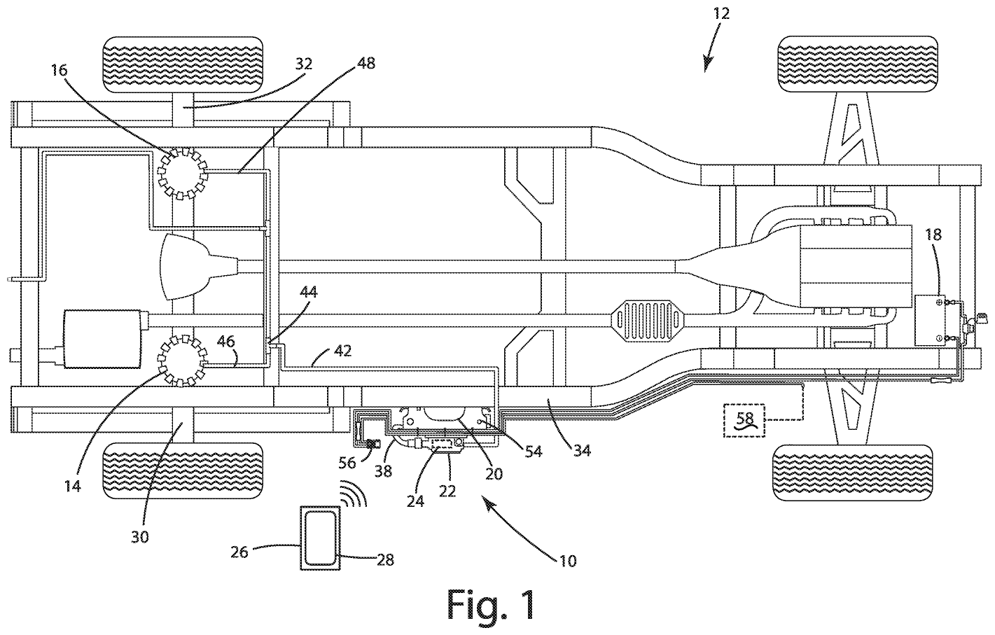

An air suspension control system according to one embodiment of the present invention is shown in FIG. 1 and generally designated 10. The control system 10 is operable to raise and lower the height of a vehicle 12 based in part on the response characteristics of the vehicle's suspension and vehicle loading. In the illustrated embodiment, the suspension of the vehicle 12 includes air springs 14, 16 adapted to inflate and deflate in order to raise and lower the height of the vehicle 12. The control system 10 may be capable of controlling the supply of air to each of the air springs 14, 16, thereby changing vehicle height. Power for operation of the control system 10 may be received from battery 18 of the vehicle. The control system 10 in the current embodiment powers-up in response to a signal from a remote device or a vehicle-movement sensor, or according to a predefined schedule, as described in further detail below.

With reference to FIG. 1, the control system 10 can include an air compressor 20, a manifold 22, and an electronic power control module 24. The manifold 22 can be capable of receiving air from the air compressor 20 and distributing that air to inflate one or more air springs 14, 16 within the vehicle 12. The control system 10 may also be capable of deflating one or more of the air springs 14, 16 by exhausting air through the manifold 22.

The control system 10 can also include a remote device 26 having a user interface 28. As described in further detail below, optionally the remote device 26 can be in wireless communication with the control module 24. The user interface 28 provides an interface for the user to program and operate the control system 10, and during operation, may display pressure information for each air spring 14, 16 in the air suspension system, among other functionality. Alternatively, instead of or in addition to remote device 26, a user interface for the control system 10 can be mounted or otherwise provided within a cabin of the vehicle 12.

For purposes of disclosure, the air compressor 20 and manifold 22 are described in connection with the control system 10, but the air compressor 20 and manifold 22 may be separate from the control system 10 in alternative embodiments. Also, although the control system 10 is described in connection with a pneumatic system (e.g., an air compressor 20 and air springs 14, 16), alternative embodiments that use fluid other than air are contemplated.

The air springs 14, 16 shown in conjunction with the embodiment of FIG. 1 function as lift mechanisms, and are mounted between a wheel axle 30, 32 and a frame or chassis 34 of the vehicle 12 so that they can raise and lower the vehicle 12 in response to being inflated or deflated. As shown in the illustrated embodiment, air spring 14 is associated with a right rear axle 30 and air spring 16 is associated with a left rear axle 32 of the vehicle 12. Additional air springs may be provided, such as air springs associated with a right and left front axle of the vehicle 12. In alternative embodiments, other lift mechanisms besides the air springs 14, 16, such another type of fluid bladder, may be used with the control system 10 to raise and lower the vehicle 12.

The manifold 22 is in fluid communication with the air springs 14, 16 and the air compressor 20 through conventional connections such as pneumatic or hydraulic hoses. The manifold 22 includes an inlet port 36 connected to the air compressor 20 for receiving air therefrom via an inlet hose 38, and an outlet port 40 that connects to the air springs 14, 16 via at least one outlet hose 42. As shown herein the outlet hose 42 branches at a T-connector 44 into first and second hoses 46, 48 coupled with one of the air springs 14, 15, respectively. The outlet port 40 is capable of supplying or exhausting air through the flow path between the air springs 14, 16 and the manifold 22. Alternatively, the manifold 22 can include individual outlet ports for each air spring 14, 16.

The manifold 22 also includes an exhaust port 50 for exhausting air from, or deflating, one or more of the air springs 14, 16. The exhaust port 50 is connected to an internal exhaust valve (not shown).

One or more mounting brackets 54 can be provided for mounting one or more of the air compressor 18, manifold 20, or control module 24 to the vehicle 12. In the illustrated embodiment, one mounting bracket 54 is provided for mounting the air compressor 18, manifold 20, and control module 24 to the chassis 34 of the vehicle 12. Optionally, the mounting bracket 54 can integrate the control module, manifold, and air compressor into a single, preassembled unit for fast installation time. Other installations schemes for the control system are also possible. The mounting bracket can attach to the chassis of the vehicle using one or more fasteners, such as self-threading screws or U-bolts.

The control system 10 can optionally include a wiring harness 56 with cables or wires for transmitting electrical power or signals. In one embodiment, the control system 10 is electrically connected to the vehicle battery 18 and is not required to couple to an ignition system of the vehicle. This can significantly reduce installation time, and can further allow the control system 10 to be installed using common mechanics tools. Optionally, the control system 10 can also be, or alternatively be, electrically connected with an ignition system 58 of the vehicle 12, such that the control system 10 can optionally power-up in response to a signal from the ignition system 58. For example, the wiring harness 56 can include an optional cable or wire for coupling with the ignition system 58 such that the control system 10 turns on with the vehicle 12 turns on. The air compressor 20 may include a ground wire 57 connected to the chassis 34 of the vehicle 12.

In the illustrated embodiment, the control module 24 is integrated with the manifold 22 in a single unit. The integrated manifold and control module 22, 24 are also shown as being preassembled with the air compressor 20 via the mounting bracket 54 as noted above. One or more of these may be separate or may be integrated with another vehicle component in alternative embodiments. For example, the manifold 22 and control module 24 may be integrated together in a unit separate from the air compressor 20; in another example, some components of the control module 24 may be integrated with the manifold 22, while other components of the control module 24 may be separate from the manifold 22.

Any combination of the air compressor 20, manifold 22, and control module 24 can optionally be provided as an aftermarket kit for aftermarket installation in a vehicle. The aftermarket kit can further comprise one or more of the remote device 26, an app for the remote device 26, the mounting bracket 54, appropriate fasteners for attachment of the mounting bracket 54 to a vehicle, the wiring harness 56, and appropriate hose lines and fittings for making the necessary fluid connections between the components of the air suspension system.

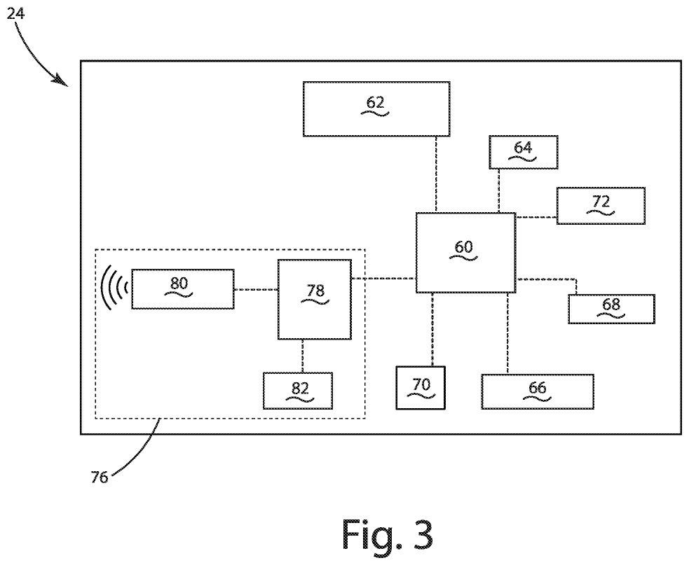

The control module 24 is configured to carry out pressure control algorithms in accordance with user input form the remote device 26 to operate the air compressor 20 and manifold 22 to inflate and deflate the air springs 14, 16 in order to raise and lower the height of the vehicle 12. One embodiment of the control module 24 is illustrated in more detail in FIG. 3. The control module 24 includes a controller 60, at least one pressure sensor 62, and at least one pressure control valve 64, such as, but not limited to, a solenoid valve. In the illustrated embodiment, these components are integrated in a single modular unit, but one or more of them may be separate from the control module 24 or be integrated with another component separate from the control module 24 in alternative embodiments. For example, the manifold 22 and control valves 64 may be integrated together in a separate component from a least some of the other components of the control module 24.

The controller 60 can include circuitry capable of controlling the state of the pressure control valve 64 and receiving sensor readings from the pressure sensor 62. Such circuitry, for example, may include a microprocessor or microcontroller programmed to control inflation, deflation, and maintenance of air pressure in the air springs 14, 16. For example, the controller 60 can include input circuitry in electrical communication with the pressure sensor 62 to monitor air pressure of the air springs 14, 16. The pressure sensor 62 may sense pressure in the flow path between the pressure control valve 64 and the air springs 14, 16, and provide an output corresponding to the sensed pressure. The controller 60 can also include output circuitry capable of controlling operation of the pressure control valve 64 in order to inflate and deflate the air springs 14, 16. For example, the controller 60 may receive communication, such as a digitized serial message or an analog signal, from each of the pressure sensor 62 representative of the air pressure of each of the air springs 14, 16. Based on this information, and optionally also based on input from the remote device 26, the controller 60 can activate one or more of the pressure control valve 64 in order to change the air pressure of the associated air springs 14, 16. The controller 60 can also include the ability to detect air leaks within the air suspension system, and notify the user of such air leaks.

The control system 10 can also comprise capability for the user to program target pressures for multiple user-defined pre-sets, each preset being tailored to different loading conditions or heights. For example, the user may program pre-sets for driver-only, driver+three passengers, full load, high height and/or low height via the remote device.

Other optional components of the control module 24 include one or more of a compressor driver 66, such as a high current compressor driver, which controls and/or operates the air compressor 20, a current sensing component (not shown) for detecting current through the compressor driver 66, an accelerometer 68 that measures the acceleration (positive and negative) of the vehicle 12, a temperature sensor 70 that measures the internal temperature of the manifold 22 in order to ensure the manifold 22 operates within a predetermined temperature range, a current/voltage regulator 72 to maintain a constant voltage level regardless of changes to input voltage or load conditions, and a wireless communication interface 76 configured to wirelessly communicate with an external component, such as the remote device 26. The control module can also include an electrical interface configured to communicate with external components, the battery 18 and optionally the ignition system 58. Optionally, the compressor driver 66 can drive an external relay to drive a larger compressor with a higher current draw than the compressor drive circuit is rated for.

The wireless communication interface 76 can include a communications controller or microcontroller unit (MCU) 78 in operable communication with the main controller 60, a wireless antenna 80, and a watchdog 82 that ensures the communications controller 78 is operating normally. In one example, the wireless communication interface 76 can be a Bluetooth® interface including a Bluetooth® microcontroller unit (MCU) 78 and a Bluetooth® antenna 80. The wireless communication interface 76 can be a wireless circuit made up of multiple components or a wireless module.

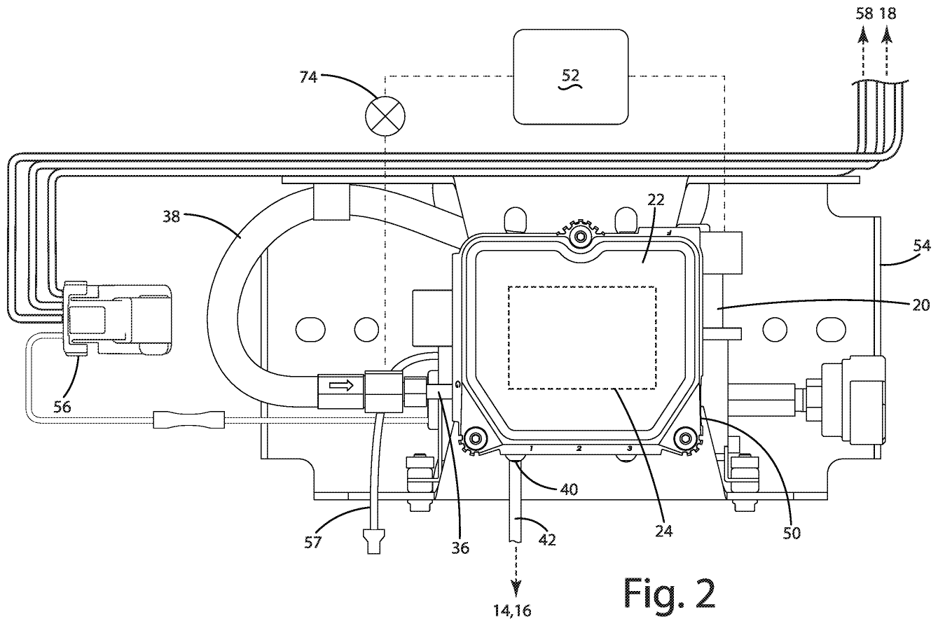

Optionally, with reference to FIG. 2, the control system 10 can include a tank 52 located between the air compressor 20 and the manifold 22. For example, the inlet port 36 of the manifold 22 can be coupled with an outlet of the tank 52. An external solenoid valve 74 can be provided in the flow path between the tank 52 and the inlet port 36, and can control air flow from the tank 52 into the manifold 22. With the optional tank 52, the compressor driver 66 of the control module 24 can drive the solenoid valve 74. The tank 52 and valve 74 are schematically illustrated in FIG. 2. Optionally, the mounting bracket 54 can integrate the tank 52 and valve 74 with the control module 24, manifold 22, and air compressor 20 into a single, preassembled unit for fast installation time. Other installations schemes for the tank 52 and valve 74 are also possible.

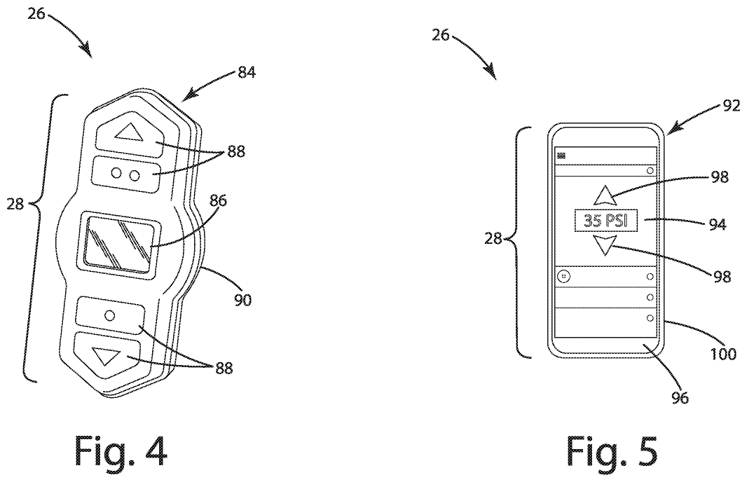

Turning to FIG. 4, in one embodiment, the remote device 26 can be a wireless remote control 84 including command circuitry (not shown) capable of wirelessly communicating with the control module 24 and a user interface 28 having a display 86 and one or more user input controls 88. The wireless remote control 84 further includes a hand-held casing or body 90 which mounts or otherwise carries the display 86 and the input controls 88. As shown herein, the display 86 can be separate from the one or more user input controls 88, which can be provided as or more physical buttons on the body 90. Alternatively, the display 86 can be a touchscreen with integrated input controls 88.

The user interface 28 can be adapted for entering commands for raising or lowering the vehicle 12, including user selection of one or more presets corresponding to a target pressure within the air springs 14, 16, which may be associated with a desired vehicle height. The display 88 can show air spring pressure and other notifications, such as battery life for the remote control 84, the sleep state of the control module 24, and status of a wireless connection with the control module 24.

Turning to FIG. 5, in another embodiment, the remote device 26 can be a smartphone 92 running an app 94. The smartphone 92 can include command circuitry (not shown) capable of wirelessly communicating with the control module 24 and a user interface 28 having a touchscreen 96 and one or more user input controls provided as one of more touchscreen controls 98 on the touchscreen 96. The smartphone 92 further includes a hand-held casing or body 100 which mounts or otherwise carries the touchscreen 96. Alternatively, one or more of the user input controls 98 can be provided as or more physical buttons on the body 100.

The touchscreen 96 can be adapted for entering commands for raising or lowering the vehicle 12, including user selection of one or more presets corresponding to a target pressure within the air springs 14, 16, which may be associated with a desired vehicle height. Via the app 94, the touchscreen 96 can show air spring pressure and other notifications, such as the sleep state of the control module 24 and the status of a wireless connection with the control module 24.

The control module 24 can default to a sleep state to preserve battery life for the vehicle battery 18. The sleep state of the control module 24 can be a low power or low current mode in which components of the control system 10 are switched off. Upon receiving a wake trigger, which can be input to the controller 60, the control module 24 can enter an awake state in which components of the control system 10 are switched on. The wake trigger can be periodically generated automatically at a predefined time interval or generated aperiodically based on input to the controller 60. For example, a wake trigger can be based on input from an on-board (i.e., on the vehicle) sensor or an external sensor. Examples of on-board sensors which can be used to cause or generate a wake trigger includes the pressure sensor 62 or the accelerometer 68. In another example, a wake trigger can be message from the wireless remote device 26. In some embodiments, the control module 24 can be responsive to multiple different wake triggers.

In some embodiments, a wake trigger can be based on sensors internal to the control system itself, as opposed to on-board sensors at large. Further the wake trigger can be generated without monitoring a wired trigger input external to the control system, such as a vehicle ignition signal. That is, the wake trigger can be generated without the use of electrical signals external to the control module. Instead, by monitoring sensors internal to the control module 24, the control module can detect vehicle motion and assume that the ignition is on and therefore generate a wake trigger.

Optionally, during installation, upon the first battery and ground connection, the control module 24 can stay awake for a predetermined time interval and not immediately go to sleep. In one embodiment, the predetermined time interval for the sleep delay is approximately one second. After the time interval, the control module 24 can enter the sleep state. This sleep delay upon installation can be helpful to verify the current state of one or more wake triggers and if no wake triggers are active, the control module 24 enters sleep mode.

Also optionally, if the control system 10 is electrically connected with the ignition system 58 of the vehicle 12, the wake trigger can be an ignition signal or other ignition input received by the controller 60. This option is helpful if used in conjunction with other wake triggers and also with an automatic return to the sleep state after a predetermined wake time, as described below.

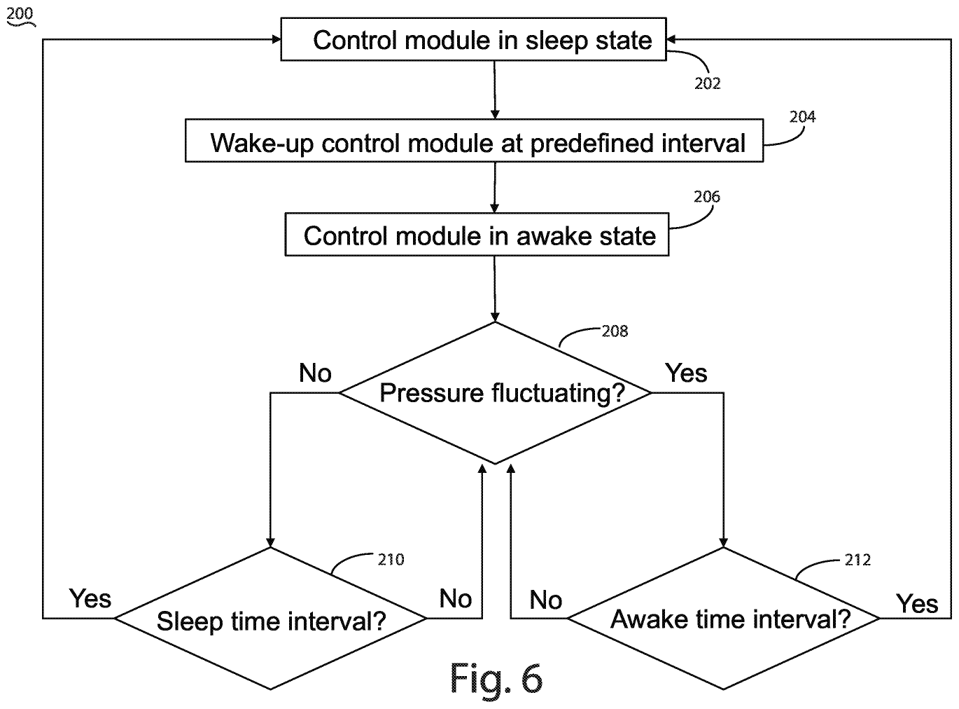

One embodiment of a method for operating the air suspension control system 10 is illustrated in FIG. 6 and generally designated 200. The sequence of steps discussed is for illustrative purposes only and is not meant to limit the method in any way as it is understood that the steps may proceed in a different logical order, additional or intervening steps may be included, or described steps may be divided into multiple steps, without detracting from the invention. The method 200 is described with respect to the control system 10 discussed for FIGS. 1-5, although it is understood that the method 200 is not limited to the particular embodiment of FIGS. 1-5.

The method 200 begins with the control module 24 in a sleep state at step 202. Periodically, such as at a predefined interval at step 204, the control module 24 is configured to wake-up and enter an awake state at step 206. Specifically, a wake trigger is automatically generated by the controller 60 after the elapse of the predefined time interval at step 204, and the components of the control system 10 are switched on.

Next, at step 208 it is determined if a condition exists in the control system 10 or in the vehicle 12 to remain awake. One such condition is whether the vehicle 12 is moving. If the vehicle 12 is not moving, the air suspension system will not be in use and the control module 24 can go back to sleep to conserve power. In the illustrated embodiment, at step 208 the controller 60 checks the condition of at least one pressure sensor 62 to determine if pressure fluctuations are present in the flow path between the pressure control valve 64 and the air springs 14, 16. The controller 60 interprets pressure fluctuations in the sensor readings as an indication that the vehicle 12 is moving and that the ignition system of the vehicle 12 is on. For example, if pressure fluctuations exceed a pre-defined threshold the fluctuations are indicative that the vehicle 12 is moving and that the ignition system of the vehicle 12 is on. That is, the pressure fluctuations can be used to simulate a vehicle ignition or “vehicle on” signal without an external wired trigger to the ignition. With the ignition system of the vehicle 12 on, the alternator is charging the electrical system and a low current sleep state is no longer needed. Once awake, the control module 24 can carry out pressure control algorithms in accordance with user input form the remote device 26. Optionally, the pre-defined threshold for pressure fluctuation can be a static threshold of about 0.5-2.0 psi. Alternatively, the pre-defined threshold for pressure fluctuation can be a dynamic threshold, such that different applications have different pre-defined thresholds. Using a threshold above 0 psi can be useful to filter out fluctuations detected when the vehicle 12 is stationary but under heavy wind conditions. Also, positive pressure above 0 psi can also generated by air trapped in the air springs 14, 16 and load being applied to the vehicle 12, even when the vehicle 12 is not moving. Alternatively, instead of using a threshold, the system can be configured to interpret any pressure fluctuation as an indication that the vehicle 12 is moving and no pressure fluctuation as an indication that the vehicle 12 is not moving.

If a condition does not exist in the control system 10 or in the vehicle 12 for the control module 24 to remain awake, i.e., if pressure fluctuations in the flow path between the pressure control valve 64 and the air springs 14, 16 are not detected, or if the pressure fluctuations do not exceed the pre-defined threshold, the control module 24 returns to the sleep state. As shown in FIG. 6, the control module 24 can delay returning to sleep for a short time interval at step 210 while it is determined whether pressure fluctuation is detected. Once the time interval passes without any detection of pressure fluctuation, the control module 24 returns to the sleep state at step 202.

If a condition does exist in the control system 10 or in the vehicle 12 for the control module 24 to remain awake, i.e., if pressure fluctuations in the flow path between the pressure control valve 64 and the air springs 14, 16 are detected, the control module 24 remains awake for a predefined time interval at step 212. During this wake time, the control module 24 can carry out pressure control algorithms in accordance with user input form the remote device 26. After the predefined time interval at step 212 elapses, the control module 24 returns to the sleep state at step 202.

For method 200, the periodic wake-up frequency and time awake can be set so that the overall duty cycle of the control module 24 is very low and so the average current draw on the battery 18 remains low. In one example, the control module 24 can periodically wake up at a predefined interval in the range of 5-10 minutes, inclusive, at step 204 and if pressure fluctuations are detected, the control module 24 can remain awake for a predefined wake time interval of 3 minutes. Using such a timing, the average current draw of the control module 24 remains below 1 milliamps (mA). 1 mA is well below the current draw of most aftermarket control modules for air suspension systems. The minimum predefined time interval for staying awake at step 210 can be 1-3 seconds.

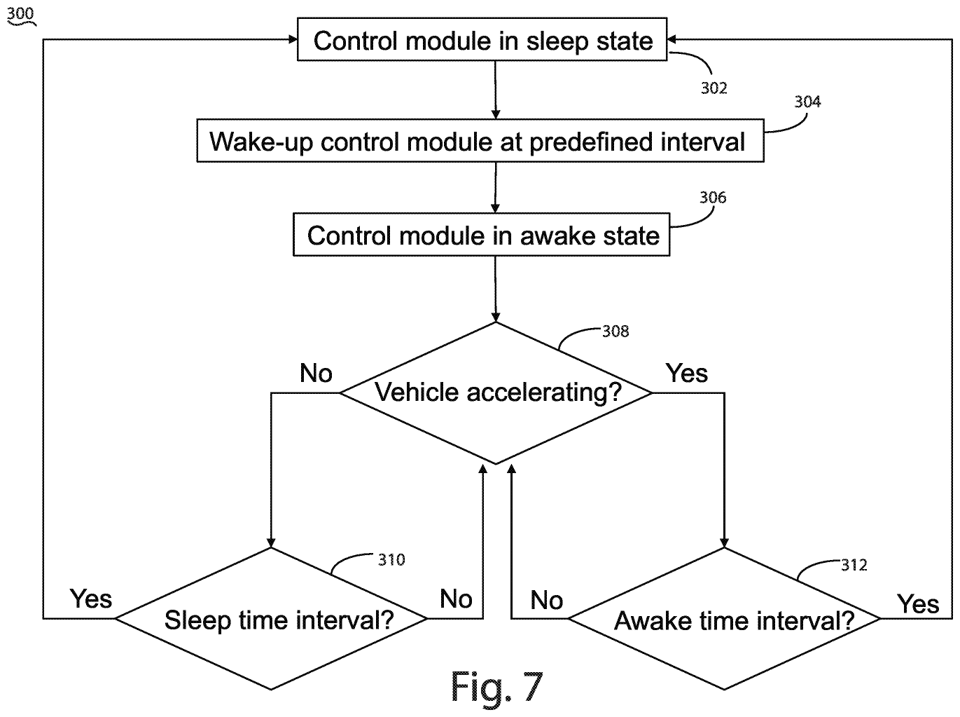

Another embodiment of a method for operating the air suspension control system 10 is illustrated in FIG. 7 and generally designated 300. The sequence of steps discussed is for illustrative purposes only and is not meant to limit the method in any way as it is understood that the steps may proceed in a different logical order, additional or intervening steps may be included, or described steps may be divided into multiple steps, without detracting from the invention. The method 300 is described with respect to the control system 10 discussed for FIGS. 1-5, although it is understood that the method 300 is not limited to the particular embodiment of FIGS. 1-5.

The method 300 begins with the control module 24 in a sleep state at step 302. Periodically, such as at a predefined interval at step 304, the control module 24 is configured to wake-up and enter an awake state at step 306. Specifically, a wake trigger is automatically generated by the controller 60 after the elapse of the predefined time interval at step 304, and the components of the control system 10 are switched on.

Next, at step 308 it is determined if a condition exists in the control system 10 or in the vehicle 12 to remain awake. In the illustrated embodiment, at step 308 the controller 60 checks the sensor readings of the accelerometer 68 to determine if the vehicle 12 is accelerating. The controller 60 interprets acceleration (including positive or negative acceleration) of the vehicle 12 as an indication that the ignition system of the vehicle 12 is on. With the ignition system of the vehicle 12 on, the alternator is charging the electrical system and a low current sleep state is no longer needed. Once awake, the control module 24 can carry out pressure control algorithms in accordance with user input form the remote device 26.

If a condition does not exist in the control system 10 or in the vehicle 12 for the control module 24 to remain awake, i.e., if no acceleration is detected, the control module 24 returns to the sleep state. As shown in FIG. 7, the control module 24 can delay returning to sleep for a short time interval at step 310 while it is determined whether acceleration is detected. Once the time interval passes without any detection of acceleration, the control module 24 returns to the sleep state at step 302.

If a condition does exist in the control system 10 or in the vehicle 12 for the control module 24 to remain awake, i.e., if acceleration is detected, the control module 24 remains awake for a predefined time interval at step 312. During this wake time, the control module 24 can carry out pressure control algorithms in accordance with user input form the remote device 26. After the predefined time interval at step 312 elapses, the control module 24 returns to the sleep state at step 302.

For method 300, the periodic wake-up frequency and time awake can be set so that the overall duty cycle of the control module 24 is very low and so the average current draw on the battery 18 remains low. In one example, the control module 24 can periodically wake up at a predefined interval in the range of 5-10 minutes, inclusive, at step 304 and if pressure fluctuations are detected, the control module 24 can remain awake for a predefined wake time interval of 3 minutes. Using such a timing, the average current draw of the control module 24 remains below 1 milliamps (mA). 1 mA is well below the current draw of most aftermarket control modules for air suspension systems. The minimum predefined time interval for staying awake at step 310 can be 1-3 seconds.

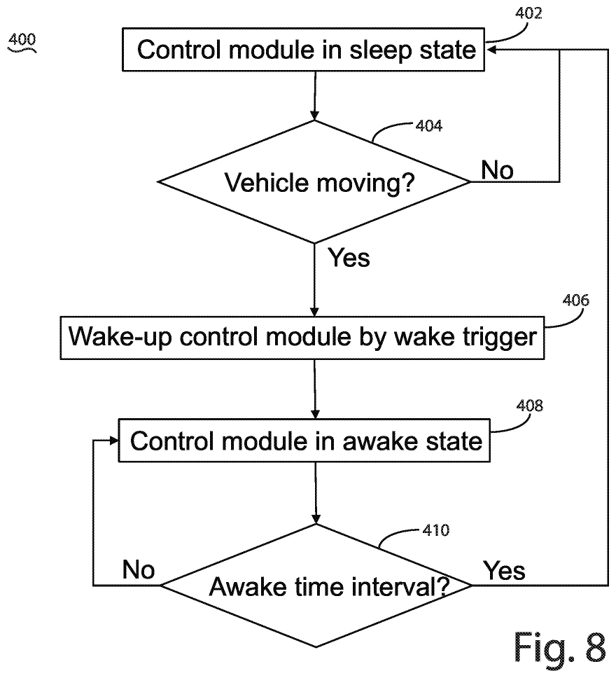

In other embodiments where input from sensors having a digital or analog output is used to determine if the vehicle 12 is moving, a threshold value can be set for generating a wake trigger, rather than waiting for the elapse of a predefined wake interval, such as at steps 204 and 304 of the previous methods 200 and 300. One such embodiment of a method for operating the air suspension control system 10 is illustrated in FIG. 8 and generally designated 400. The sequence of steps discussed is for illustrative purposes only and is not meant to limit the method in any way as it is understood that the steps may proceed in a different logical order, additional or intervening steps may be included, or described steps may be divided into multiple steps, without detracting from the invention. The method 400 is described with respect to the control system 10 discussed for FIGS. 1-5, although it is understood that the method 400 is not limited to the particular embodiment of FIGS. 1-5.

The method 400 begins with the control module 24 in a sleep state at step 402. At step 404, it is determined if the vehicle is moving or not moving. In the illustrated embodiment, at step 404 the controller 60 receives a sensor reading from the accelerometer 68. The accelerometer 68 can have a direct output connection to the main controller 60 so a periodic wake up of the main controller 60 is not necessary. The accelerometer 68 can have a microcontroller embedded therein that remains on all the time with a very low power draw, and can be programmed with an predetermined threshold value, which can be predetermined acceleration threshold, and which, once reached, triggers an output signal to the main controller 60 to wake up.

If the sensor reading is below the predetermined threshold value, the vehicle is determined to be not moving, the control module 24 remains in the sleep state.

If the sensor reading is at or above the predetermined threshold value, the vehicle is determined to be moving, and a wake trigger is generated by the controller 60 at step 406. The control module 24 is configured to wake-up and enter an awake state at step 408 in which the components of the control system 10 are switched on.

Alternatively, at step 404 the controller 60 can receive a sensor output from a pressure sensor 62. Depending on the output of the pressure sensor, the control system can determine if pressure fluctuations are present in the flow path between the pressure control valve 64 and the air springs 14, 16. The controller 60 can interpret the pressure fluctuations in the sensor readings as an indication that the vehicle 12 is moving and that the ignition system of the vehicle 12 is on, as discussed above with the decision to stay awake in connection with FIG. 6. The indication that the vehicle is moving can be in turn be used by the controller 60 to generate a wake trigger and wake up the control module 24 at step 406.

Once awake, the control module 24 can carry out pressure control algorithms in accordance with user input form the remote device 26. The control module 24 can remain awake for a predefined time interval at step 410. Optionally, the predefined time interval can be 3 minutes. The awake time interval 410 may begin as soon as or a pre-determined amount of time after the control muddle 24 enters an awake state. Alternatively, the awake time interval 410 may start after there is no or a sufficiently low amount of activity. For example, a sufficient lack in vehicle movement can start the awake time interval at step 410. After the predefined time interval at step 410 elapses, the control module 24 returns to the sleep state at step 402.

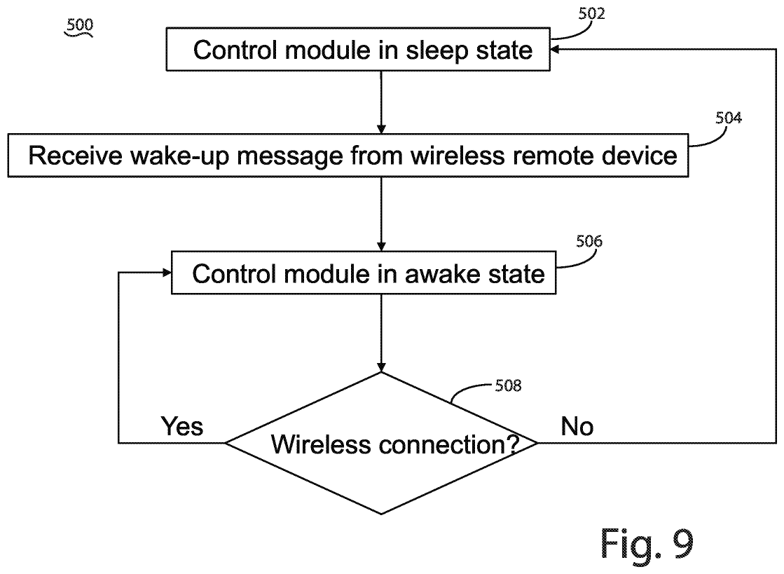

In other embodiments, the wake trigger can be initiated by the remote device 26, rather than being generated based on the elapse of a predetermined time interval or based on sensor input. One such embodiment of a method for operating the air suspension control system 10 is illustrated in FIG. 9 and generally designated 500. The sequence of steps discussed is for illustrative purposes only and is not meant to limit the method in any way as it is understood that the steps may proceed in a different logical order, additional or intervening steps may be included, or described steps may be divided into multiple steps, without detracting from the invention. The method 500 is described with respect to the control system 10 discussed for FIGS. 1-5, although it is understood that the method 500 is not limited to the particular embodiment of FIGS. 1-5.

The method 500 begins with the control module 24 in a sleep state at step 502. At step 504, the controller 60 receives a wake trigger in the form of a wake-up message from the remote device 26. Specifically, the communication controller 78 wakes up periodically in a very low current state, broadcasts a beacon, and listens for a response. When the remote device 26 is powered on and sees the beacon and it sends a signal to the main controller 60 to establish a wireless connection between the control module 24 and the remote device 26. The wake-up message can be the request from the remote device 26 to connect with the control module 24. Once connected or paired with the remote device 26, the control module 24 is configured to enter an awake state at step 506 in which the components of the control system 10 are switched on. Once awake, the control module 24 can carry out pressure control algorithms in accordance with user input form the remote device 26.

The wake trigger can be generated without monitoring a wired trigger input external to the control system, such as a vehicle ignition signal. That is, the wake trigger can be generated without reference to any wired electrical signals external to the control module. Instead, by monitoring sensors internal to the control module 24, in this case receipt of a wireless signal from a remote device via the communication interface 76 or a component thereof, the control module can generate a wake trigger for the controller 60. In this way, the control module 24 can be woken up by a wireless signal communicated to the control module 24.

The control module 24 can remain awake until the wireless connection is closed. For example, at step 508, it is determined if the wireless connection is still open. If it is, the control module 24 remains awake. If the wireless connection is closed, the control module 24 returns to the sleep state at step 502. Optionally, there is a delay before returning the sleep state after the wireless connection is closed. In one embodiment, the predetermined time interval for the delay is approximately 3 minutes.

The methods of operating the control system described herein with respect to FIGS. 6-9 can be used independently, or optionally, one or more of the methods can be combined. In such method combinations, the control module can always return to a low-current sleep state after a defined awake time interval or loss of established wireless connection with the remote device, whether initially awoken via a wake trigger based on a predefined wake time interval, vehicle movement, or a wireless wake-up message. For example, in a typical truck application with air springs 14, 16 mounted on the rear axle, a user may add or remove a load from the truck bed and expect a pressure adjustment from the control module 24 within a short time. If the load change is made while the control module 24 is in the sleep state and before the predefined wake time interval, the pressure adjustment is not be made. However, because the control module 24 can also be awoken via aperiodic wake triggers based on vehicle movement or wireless messages, the system can make any adjustments needed to accommodate the load change without waiting for the period wake trigger. A similar scenario can exist for vehicle applications where a minimum air pressure must be maintained in the air springs 14, 16 while moving. Once the vehicle starts moving, this movement is detected and the wake trigger is generated without waiting for the predefined wake time interval or a wireless wake-up message, and the system can make any adjustments needed to maintain the minimum air pressure required.

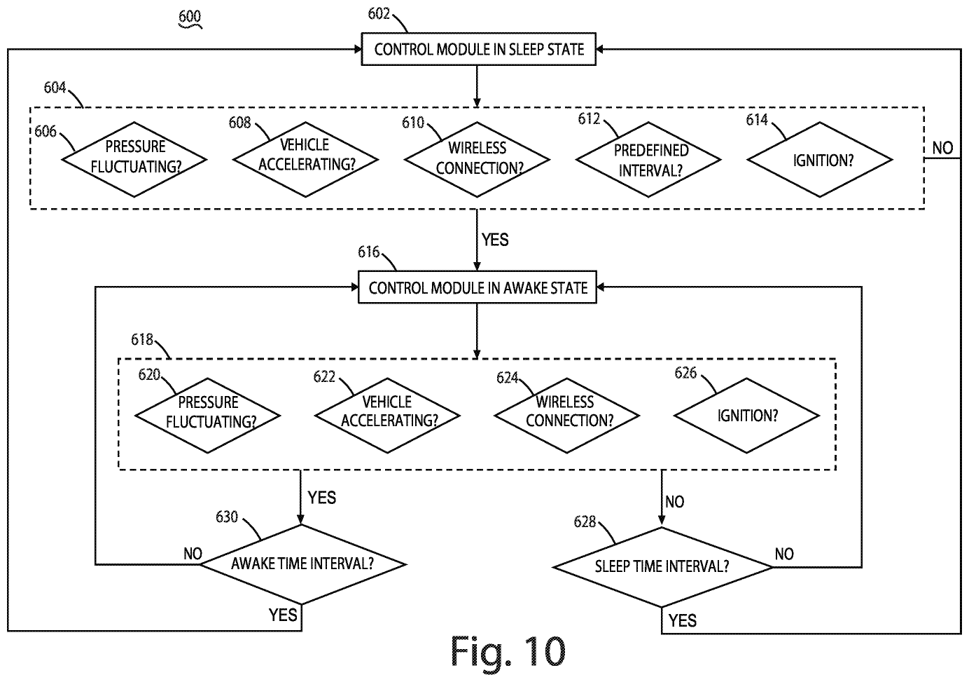

Another embodiment of a method for operating the air suspension control system 10 is illustrated in FIG. 10 and generally designated 600. The sequence of steps discussed is for illustrative purposes only and is not meant to limit the method in any way as it is understood that the steps may proceed in a different logical order, additional or intervening steps may be included, or described steps may be divided into multiple steps, without detracting from the invention. The method 600 is described with respect to the control system 10 discussed for FIGS. 1-5, although it is understood that the method 600 is not limited to the particular embodiment of FIGS. 1-5.

The method 600 begins with the control module 24 in a sleep state at step 602. At step 604, it is determined if a condition exists in the control system 10 or in the vehicle 12 for waking the control module 24, via a wake trigger or otherwise. Examples of such conditions include, but are not limited to, whether the vehicle 12 is moving, whether a wireless connection with the remote device 26 is established, whether a predefined time interval has elapsed, and/or whether the ignition of the vehicle 12 is on. In the illustrated embodiment, at step 604, the controller 60 can determine if there is a pressure fluctuation condition 606. Specifically, the controller can determine the condition of at least one pressure sensor 62 to determine if pressure fluctuations are present in the flow path between the pressure control valve 64 and the air springs 14, 16, as described above with respect to step 208 of FIG. 6. At step 604, the controller 60 can determine if there is a vehicle acceleration condition 608. Specifically, the controller 60 can check the sensor readings of the accelerometer 68 to determine if the vehicle 12 is accelerating, as described above with respect to step 308 of FIG. 7. At step 604, the controller 60 can determine if there is a wireless connection condition 610. Specifically, the controller 60 can determine if there is a wireless connection, such as a Bluetooth® connection, established with the remote device 26. At step 604, the controller 60 can determine if there is a predefined time interval condition 612. Specifically, the controller 60 can determine whether a predefined time interval has elapsed, as described above with respect to steps 204 and 304 of FIGS. 6 and 7. At step 604, if the control system 10 is electrically connected with the ignition system 58 of the vehicle 12, the controller 60 can determine if there is an ignition condition 614. Specifically, an ignition signal or other ignition input can be detected by the controller 60. Any combination of one or more of the conditions 606-614 can be checked at step 604, and further any of these conditions 606-614 may be checked in parallel or sequentially, in any order and/or at any frequency.

If a condition does not exist in the control system 10 or in the vehicle 12 for the control module 24 to wake, i.e., if each condition 606-614 checked at step 604 is negative, which can include no or a sufficiently low amount of activity for each condition 606-614, then the control module 24 can remain in the sleep state.

If a condition does exist in the control system 10 or in the vehicle 12 for the control module 24 to wake, i.e., if any one of the conditions 606-614 checked at step 604 is positive, then the control module 24 can wake-up and enter an awake state at step 616. A wake trigger can be generated by the controller 60 after any one of the conditions 606-614 checked at step 604 is positive, and the components of the control system 10 are switched on. Once awake, the control module 24 can carry out pressure control algorithms in accordance with user input form the remote device 26.

At step 618, it is determined if a condition exists in the control system 10 or in the vehicle 12 for the control module 24 to remain awake. Examples of such conditions include, but are not limited to, whether the vehicle 12 is moving, whether a wireless connection with the remote device 26 is established, and/or whether the ignition of the vehicle 12 is on. In the illustrated embodiment, at step 618, the controller 60 can determine if there is a pressure fluctuation condition 620. Specifically, the controller can determine the condition of at least one pressure sensor 62 to determine if pressure fluctuations are present in the flow path between the pressure control valve 64 and the air springs 14, 16, as described above with respect to step 208 of FIG. 6. At step 618, the controller 60 can determine if there is a vehicle acceleration condition 622. Specifically, the controller 60 can check the sensor readings of the accelerometer 68 to determine if the vehicle 12 is accelerating, as described above with respect to step 308 of FIG. 7. At step 618, the controller 60 can determine if there is a wireless connection condition 624. Specifically, the controller 60 can determine if there is a wireless connection, such as a Bluetooth® connection, established with the remote device 26. At step 618, if the control system 10 is electrically connected with the ignition system 58 of the vehicle 12, the controller 60 can determine if there is an ignition condition 626. Specifically, an ignition signal or other ignition input can be detected by the controller 60. Any combination of one or more of the conditions 620-626 can be checked at step 618, and further any of these conditions 620-626 may be checked in parallel or sequentially, in any order and/or at any frequency.

If a condition does not exist in the control system 10 or in the vehicle 12 for the control module 24 to remain awake, i.e., if each condition 620-626 checked at step 618 is negative, which can include no or a sufficiently low amount of activity for each condition 620-626, then the control module 24 returns to the sleep state. As shown in FIG. 10, the control module 24 can delay returning to sleep for a short time interval at step 628. Optionally, this time interval can be approximately 3 minutes. Once the time interval passes, the control module 24 returns to the sleep state at step 602.

If a condition does exist in the control system 10 or in the vehicle 12 for the control module 24 to remain awake, if any one of the conditions 620-626 checked at step 604 is positive, then the control module 24 can remain awake. Optionally, the control module 24 can remain awake effectively indefinitely while it remains that any one of the conditions 620-626 checked at step 604 is positive. Alternatively, as shown in FIG. 10, the control module 24 can remain awake only for a predefined time interval at step 630. After the predefined time interval at step 630 elapses, the control module 24 returns to the sleep state at step 602.

While discussed herein with respect to a control system for an air suspension system, the embodiments of the methods disclosed herein can be applied to other vehicle control modules, such as power control modules, ignition control modules, fuel injection modules, brake control modules, LED lighting control modules, tire pressure sensor modules, liftgate control modules, Wi-Fi control modules, audio head unit modules, semi-active suspension control modules, active suspension control modules, leveling control modules, fan motor control modules, seat control modules, trailer hitch control modules, heater control modules, and/or climate control modules.

There are several advantages of the present disclosure arising from the various features of the methods, systems, and apparatus described herein. For example, the embodiments of the invention described above utilize a wake trigger that closely simulates vehicle ignition without requiring an actual connection to the ignition source. Original equipment manufacturers and the aftermarket industry currently utilize wired connections to wake up vehicle control modules, which requires connection to the ignition system of the vehicle. Embodiments of the methods disclosed herein are unique in that no electrical signal external of the control module is required. In some embodiments, by simply monitoring onboard sensors, the control module can detect vehicle motion, assume that the ignition is on, and wake-up. Other embodiments of the methods disclosed herein are unique in that they utilize a wireless message or Bluetooth® wake-up trigger from a remote device to wake-up the control module. In either case, the control system is installed faster than conventional systems, since no electrical wiring needs to be run to the cab or ignition of the vehicle. The embodiments of the invention described above utilize an electrical connection to the vehicle battery, without generating a constant power draw on the battery.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method of operating a control system for an air suspension system of a vehicle having a battery and an air spring adapted to inflate and deflate in order to raise and lower the height of the vehicle, the method comprising:
providing a control module, electrically coupled with the battery, with a default sleep state comprising a low power mode;
generating a wake trigger to switch the control module from the sleep state to an awake state, wherein the wake trigger is at least one of a periodic wake trigger automatically generated after the elapse of a predefined time interval or an aperiodic wake trigger generated after the detection of movement of the vehicle; and
switching the control module from the awake state to back to the sleep state.

2. The method of claim 1, wherein the predefined time interval is 5-10 minutes.

3. The method of claim 2, wherein the predefined wake period is 3 minutes.

4. The method of claim 1, and further comprising determining if the vehicle is moving or not moving by monitoring sensors internal to the control system without monitoring a wired trigger input external to the control system.

5. The method of claim 4, wherein determining if the vehicle is moving comprises sensing pressure in a flow path between a pressure control valve and the air spring via a pressure sensor onboard the vehicle, wherein if a pressure fluctuation detected in the sensed pressure does not exceed a pre-defined threshold, the vehicle is determined to be not moving.

6. The method of claim 4, wherein determining if the vehicle is moving comprises sensing acceleration of the vehicle via an accelerometer onboard the vehicle, wherein if no acceleration is detected, the vehicle is determined to be not moving.

7. The method of claim 1, further comprising carrying out a pressure control algorithm while the control module is awake.

8. The method of claim 7, wherein carrying out the pressure control algorithm comprises operating an air compressor and a manifold to distribute air to the air spring.

9. The method of claim 1, wherein the wake trigger is generated based on the first to occur of: the elapse of the predefined time interval or the detection of movement of the vehicle.

10. The method of claim 1, further comprising establishing a wireless connection between the control module and a wireless remote device comprising a user interface with a display and at least one input control.

11. The method of claim 1, further comprising sending a wake-up message from the wireless remote device to the control module to switch the control module from the sleep state to an awake state.

12. A method of operating a control system for an air suspension system of a vehicle having a battery and an air spring adapted to inflate and deflate in order to raise and lower the height of the vehicle, the method comprising:
providing a control module with a default sleep state comprising a low power mode;
generating a wake trigger to switch the control module from the sleep state to an awake state;
determining if the vehicle is moving or not moving; and
switching the control module from the awake state to back to the sleep state if the vehicle is determined to be not moving.

13. The method of claim 12, wherein issuing the wake trigger comprises issuing the wake trigger at a predefined time interval.

14. The method of claim 13, wherein the predefined time interval is 5-10 minutes.

15. The method of claim 14, wherein, if the vehicle is determined to be moving, switching the control module from the awake state to back to the sleep state after a wake period of 3 minutes.

16. The method of claim 12, wherein determining if the vehicle is moving comprises sensing pressure in a flow path between a pressure control valve and the air spring via a pressure sensor onboard the vehicle, wherein if a pressure fluctuation detected in the sensed pressure does not exceed a pre-defined threshold, the vehicle is determined to be not moving.

17. The method of claim 12, wherein determining if the vehicle is moving comprises sensing acceleration of the vehicle via an accelerometer onboard the vehicle, wherein if no acceleration is detected, the vehicle is determined to be not moving.

18. The method of claim 13, wherein determining if the vehicle is moving comprises monitoring sensors internal to the control system without monitoring a wired trigger input external to the control system.

19. A method of operating a control system for an air suspension system of a vehicle having a battery and an air spring adapted to inflate and deflate in order to raise and lower the height of the vehicle, the method comprising:
providing a control module with a default sleep state comprising a low power mode;
determining if the vehicle is moving or not moving; and
generating a wake trigger to switch the control module from the sleep state to an awake state if the vehicle is determined to be moving.

20. The method of claim 19, wherein determining if the vehicle is moving or not moving comprises monitoring sensors internal to the control system without monitoring a wired trigger input external to the control system.
